(19) United States
(12) Patent Application Publication
(10) Pub. No.: US 2016/0070802 A1
(43) Pub. Date: Mar. 10, 2016

(54) METHODS AND SYSTEMS OF A MOBILE INTERFACE PLATFORM

(71) Applicant: Ali ALSANOUSI, Boston, MA (US)

(72) Inventor: Ali ALSANOUSI, Boston, MA (US)

(21) Appl. No.: 14/480,315

(22) Filed: Sep. 8, 2014

(51) Int. Cl. G06F 17/30; H04L 29/08

(52) U.S. Cl. CPC G06F 17/30867; H04L 67/10

(57) ABSTRACT

A system and method of comparing mobile applications is described. The method includes authenticating a user access to a plurality of industry-related mobile applications for a set trial period of time, and receiving trial sequence data indicating the user's preference for each of the plurality of industry-related mobile applications for the set period of time. The method also includes generating a ranking of the plurality of industry-related mobile applications from the received trial sequence data, via a single operating platform and associated virtual machine language of a networking system. The method also includes accepting one or more of the plurality of industry-related mobile applications onto the single operating platform, based upon its associated ranking. The system includes an interoperable platform, a plurality of mobile applications that are related to a single industry and interconnected with the interoperable platform, an operating system connected to the interoperable platform, and a server.

### GRANT OF NON-EXCLUSIVE RIGHT

This application was prepared with financial support from the Saudia Arabian Cultural Mission, and in consideration therefore the present inventor(s) has granted The Kingdom of Saudi Arabia a non-exclusive right to practice the present invention.

### BACKGROUND

1. Field of the Disclosure

Systems and methods of forming a mobile interface platform are described. In particular, a mobile interface platform of evaluated and validated mobile applications is described herein. Still further, a mobile health interface platform of evaluated and validated mobile health applications is described.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Mobile applications are currently being built independently, with little or no data sharing. In contrast, the use of mobile applications is becoming multi-dimensional and evolving. A full or complete picture of mobile applications for a particular industry will require integrating, processing, and visualizing data from multiple applications and data sources.

### SUMMARY

Embodiments include a method of comparing mobile applications. The method includes authenticating a user access to a plurality of industry-related mobile applications for a set trial period of time, and receiving trial sequence data indicating the user's preference for each of the plurality of industry-related mobile applications for the set period of time. The method also includes generating a ranking of the plurality of industry-related mobile applications from the received trial sequence data, via a single operating platform and associated virtual machine language of a networking system. The method also includes accepting one or more of the plurality of industry-related mobile applications onto the single operating platform, based upon its associated ranking.

Embodiments also include a mobile application network system. The system includes an interoperable platform and associated virtual machine language, and a plurality of mobile applications that are related to a single industry and interconnected with the interoperable platform, via a networking system. Some of the plurality of mobile applications are evaluated by a user and accepted by the interoperable platform, based upon each mobile application's resultant ranking. The mobile application network system also includes an operating system connected to the interoperable platform, and a server containing a processor. Each of the plurality of mobile applications share an application programming interface with the interoperable platform, such that the mobile application network system has a single interoperable platform, a single operating system, and a single server for the plurality of mobile applications that are related to the single industry.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a networking system with multiple application types, according to one example;

FIGS. 2A-2C illustrate networking systems unique to an industry type of application, according to examples described herein;

FIG. 3 illustrates an architectural framework, according to one example;

FIG. 4 is a block diagram of a computing system, according to one example; and

FIG. 5 is a flow diagram of a method of comparing mobile applications, according to one example.

Referring now to the drawings, wherein like reference numerals designate identical or corresponding parts throughout the several views.

### DETAILED DESCRIPTION OF THE EMBODIMENTS

Mobile health, as used herein refers, in part to the incorporation of mobile telecommunication, multimedia technology, and mobile communication devices, as well as any other device used to communicate health-related matters via wireless communication for delivery of medical health services and clinical trials services. Examples of mobile health devices include, but are not limited to glucometers, pulse oximeters, pedometers, sphygmomanometers, biofeedback devices, urine analyzers, and pulmonary function test devices. These devices may be used in or out of a medical setting and may communicate wirelessly with each other.

Mobile health is an area of growth driven in part by the increasing use of mobile health products, such as mobile computing platforms, mobile health applications that run on mobile computing platforms, and peripherals. Physicians and other healthcare professionals utilize mobile computing platforms loaded with mobile health applications to improve patient care. Mobile health applications can be used to help healthcare providers more accurately estimate and calculate healthcare parameters, illustrate and explain health conditions to patients, access and edit electronic health records, and utilize peripherals, such as probes, meters, or other mobile health hardware for diagnostic purposes.

Patients can also use mobile health products to help manage particular medical conditions or their overall wellbeing. Some mobile health products are advisory in nature, such as dealing with first aid or weight management. Other mobile health products provide guidance with a medication, or monitoring health items such as glucose levels or hearth rates. Some mobile health products also communicate data to physicians in real-time.

The proliferation of healthcare data, especially generated by mobile health technology requires new ways of integrating them together to be useful for patients, physicians, researchers, and public health officers. There is a need for a mobile health platform and architecture that will bridge between health and technology to enable collaboration and provide a holistic view of a patient's health.

A large number and variety of software-based medical applications have been developed by academic and commercial entities for use in a variety of areas in the medical field, including patient diagnostics, results reporting, treatment planning, post-procedure follow up, and clinical operations. Medical applications can provide immediate or convenient access to laboratory or imaging tests, provide evidence-based clinical decision-making tools, or address operational efficiencies in healthcare by reducing paperwork or providing logistical support.

Information used by a clinician or a specialist for a patient evaluation or consultation is often based on data from one or more prior consultations, or from one or more previous diagnostic tests. However, data collected from one clinician or medical system may be incompatible or incomplete for use by another clinician or medical system. Healthcare informatics attempts to deal with this by merging information science, computer science, and health care to optimize, among other things, the acquisition, storage, retrieval, display, or use of information in healthcare or biomedicine.

A mobile health application should easily link together with other applications. An objective of embodiments described herein includes aggregating multiple types of data from multiple types of applications together, such that the patient's relevant data is integrated into a single application. Conversely, basic health data could auto-populate multiple applications. For example, most applications require certain basic information, such as gender, height, weight, and date of birth. Instead of repeating the same information for each new mobile health application, the information could be automatically populated into each subsequent application, even though the applications may be very different from one another. A common data format would provide interoperability within the different applications. An example of implementing the sharing of common data would request the user to take the data from one application and populate the information requests into another application. This would eliminate the need for repeated entry of common data.

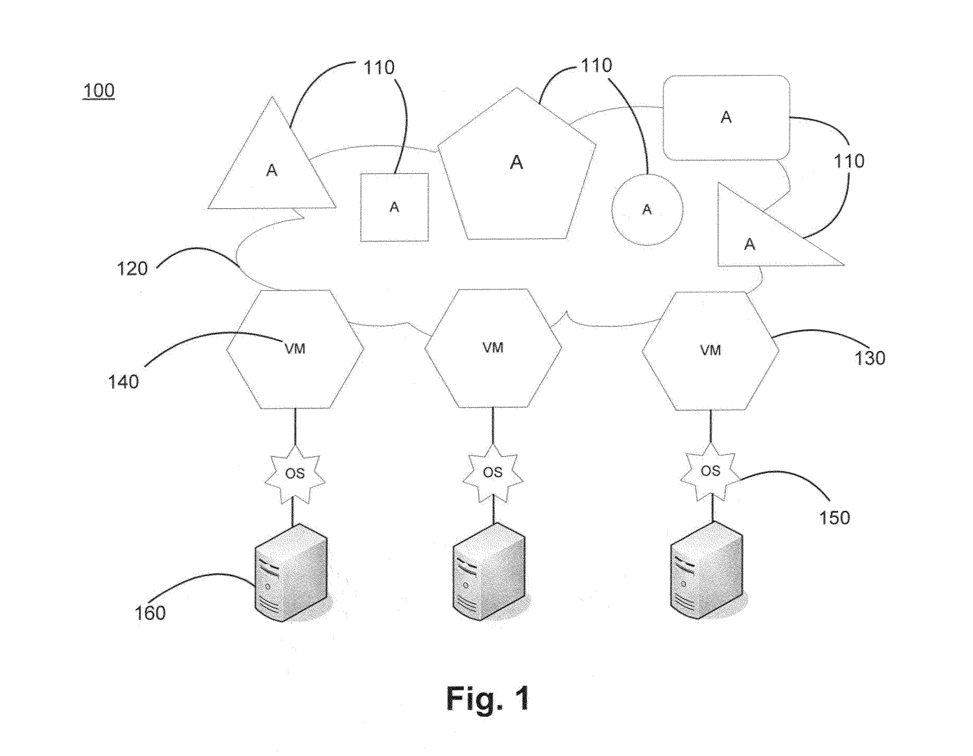

Embodiments described herein for a mobile health application platform enable data integration from multiple and varied applications. FIG. 1 illustrates a networking system 100 in which different types of mobile applications are used. Several applications 110 exist from all types of industries, as represented by different geometric symbols. Applications 110 from the health, auto, music, entertainment, food, exercise, education, and travel may be present, in addition to medical and health applications, to name just a few. The applications 110 are connected, via a cloud or network 120 to multiple platforms 130. Since the platforms 130 are not interoperable, several platforms 130 may be necessary to handle the various types of applications 110 present. Each platform 130 contains its own version of Java Virtual Machine (JVM) 140. However, other virtual machine languages which can run on multiple hardware/operating system platforms are contemplated by embodiments described herein. The individual JVMs 140 do not share data and therefore, are not integrated together. Multiple operating systems (OSs) 150 are present to operate with their associated platforms 130 and JVMs 140. Individual servers 160 are also present for each OS 150.

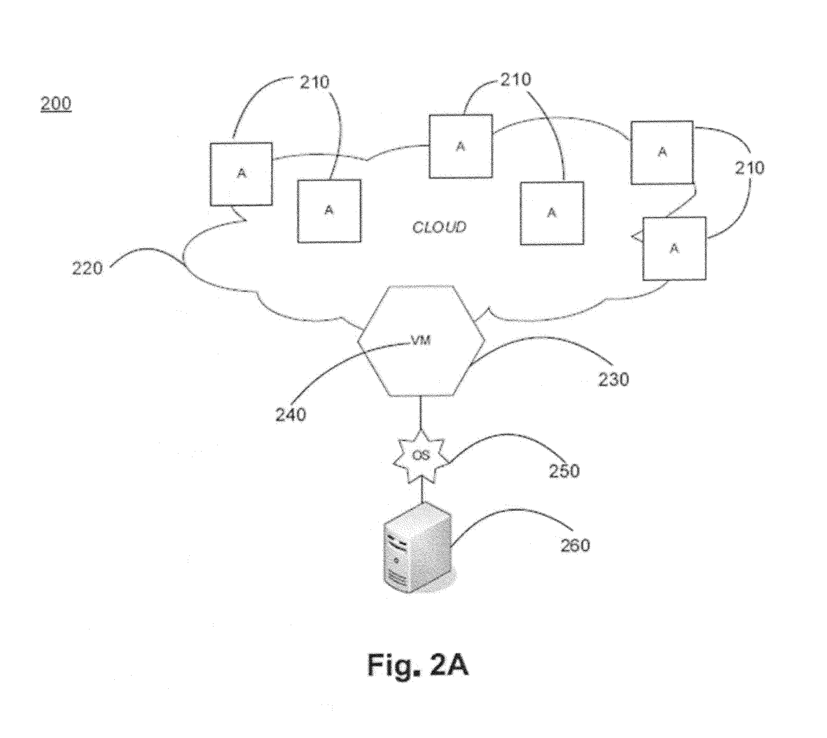

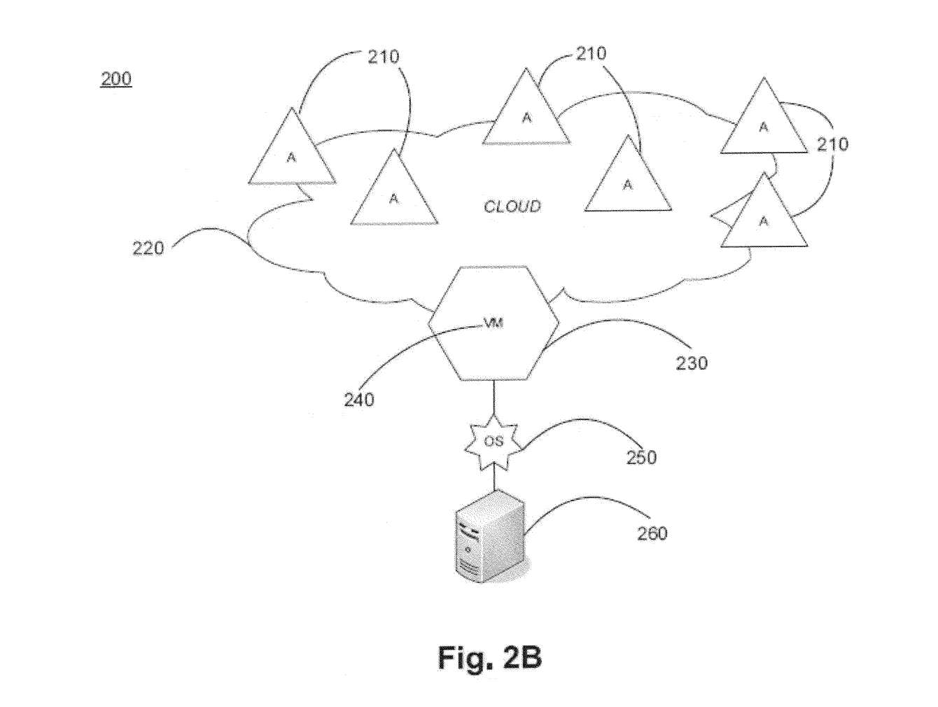

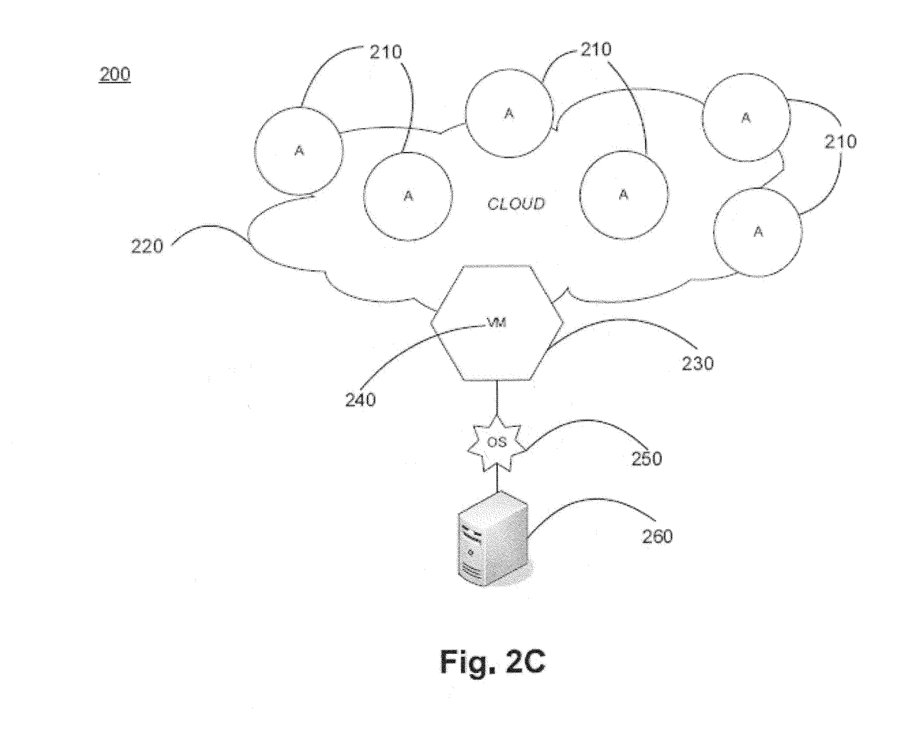

FIG. 2A illustrates a contrasting and simpler system 200 to aggregate and integrate mobile applications. As illustrated in FIG. 2A, applications 210 are aggregated into a specific industry, such as the health and medical industry, which is represented by square geometric-shaped applications. The specific industry applications 210 are connected, via a cloud or network 220 to a single interoperable and service-oriented platform 230. A single JVM 240 (or other virtual machine language) operates within the single platform 230. Since there is just one platform 230, there is a need for just one OS 250 and one server system 260.

Any other general industry could be represented by a system similar to system 200. FIG. 2B illustrates system 200 according to embodiments described herein, in which another type of industry is represented by triangle geometric-shaped applications. Likewise, FIG. 2C illustrates a system 200 according to embodiments described herein, in which yet another type of industry is represented by circle geometric-shaped applications. There could be other similar systems for any type of industry, such as the auto, music, entertainment, food, exercise, education, and travel industries, to name just a few. Any group of industry-specific applications 210 has the advantage of being integrated into a single platform 230 and governed by a single JVM 240. Each group of industry-specific applications 210 also requires just a single OS 250 and a single server system 260. As a result, a common data format provides interoperability for multiple applications 210 within an associated industry.

Most industries strive to have some type of utility measurement—a tool by which a consumer can help determine whether a particular application has utility for him/her. One reliable utility test is usage, wherein an application with a large number of users would tend to indicate that the application provides utility. Most utility measurements involve a five-star ranking system. This provides some measurement of utility, but it is limited in scope.

Embodiments described herein provide a much more direct participation approach for measuring utility and value of a mobile application. One embodiment would allow a user to “test drive” two applications within a family of related applications. The first application would be active for a limited time, after which time it becomes inactive. The second application would then become active for the same amount of time. The user would be allowed to purchase which of the two applications he/she prefers. If neither application satisfies the user, the user can continue to test other applications until a satisfactory one is found. Over time with several users “test driving” several applications, a ranking would be developed amongst the different applications.

Several evaluation criteria could be developed for a particular subset or sub-cluster of applications. For the medical and health industry as an example, a sub-cluster could be applications related to blood pressure and/or heart rate monitoring. Criteria for the user to evaluate might include clear instructions, user-friendly input, organized format, length of time to complete, reliability of connected products (e.g. blood pressure kit), and real-time results pushed to a third party (e.g. doctor's office). Each criterion would be ranked from most important to least important, along with each criterion's rating from a user. An analogy that depicts this well is an athletic ranking of several teams competing in a sport over a regular season. Criteria could include the number of wins versus losses, errors, assists, the number of tie games, a strength of each schedule, and playing time, all of which would be ranked. Each team would have their points for each criterion matched against the respective criterion ranking. This would result in that team's ranking amongst all other teams.

Several methods or models are available to evaluate a product or service. Multiple-criteria decision-making (MCDM) or multiple-criteria decision analysis (MCDA) is a discipline of operations research that explicitly considers multiple criteria in decision-making environments. One MCDM method is called Potentially All Pairwise Rankings of All Possible Alternatives (PAPRIKA). PAPRIKA is used to calculate point values or weights on the criteria or attributes for decision problems involving ranking, prioritizing, or choosing between alternatives. Point values represent the relative importance of the criteria, and are used to rank alternatives. The PAPRIKA method specifically applies to additive multi-attribute value models with performance categories. Additive multi-attribute value models have multiple criteria with two or more performance categories within each criterion, which are combined additively. Each category is worth a certain number of points that is intended to reflect both the relative importance of the criterion and its degree of achievement. For each alternative being considered, the point values are summed across the criteria to get a total score, by which the alternatives are prioritized or ranked relative to each other.

A second MCDM method is called Multi-attribute Global Inference of Quality (MAGIQ). MAGIQ is based on a hierarchical decomposition of comparison attributes and rating assignment using rank order centroids. The MAGIQ technique is used to assign a single, overall measure of quality to each member of a set of systems where each system has an arbitrary number of comparison attributes. The MAGIQ process begins with an evaluator determining which system attributes or criteria are to be used as the basis for system comparison. These criteria are ranked by importance to the particular problem domain, and the ranks are converted to ratings using rank order centroids. Each system under analysis is ranked against each comparison criterion and the ranks are transformed into rank order centroids. The final overall quality metric for each system is the weighted sum of each criterion rating.

A third MCDM method is called Measuring Attractiveness by a Categorical Based Evaluation Technique (MACBETH). MACBETH is an interactive approach that requires only qualitative judgments about differences to help a decision maker or a decision-advising group quantify the relative attractiveness of options. It employs an initial, interactive, questioning procedure that compares two elements at a time, requesting a qualitative preference judgment. As judgments are entered, a numerical scale is generated that is entirely consistent with all the decision maker's judgments, through which process weights are generated for the criteria.

Several other methods and models are available by which data can be ranked, including methods and models to compare data pairwise, in a list-wise correlation, or through multiple alignment. The three MCDM methods described above are exemplary, and embodiments described herein are not limited to any of these three methods. The three MCDM methods described above do not have any implicit or explicit order of preference.

An objective of the present disclosure is to adequately and completely rank a mobile application that will give users confidence in the application, so they can make an informed decision. Embodiments described herein provide a method of receiving an authentication to access a plurality of mobile applications containing de-identified data sets for a predetermined trial period. Following the trial period, trial sequence data is received, which indicates a user's preference for each of the plurality of applications with respect to every other application. A ranking for each of the mobile applications is generated, which is based on the trial sequence data. Acceptance of a mobile application into a particular industry platform will be based upon the calculated ranking according to applicable criteria.

Another embodiment of the present disclosure includes an algorithm, which is based upon the ranking described above, in addition to a third party validation. An example of a third party validation is an FDA approval rating. Several government and organized groups have well-established and well-known standards by which a product or service is approved or rated. A mobile application would display a greater confidence and/or utility to a prospective user when it has been approved using the systems and methods described herein, including a third-party validation or endorsement.

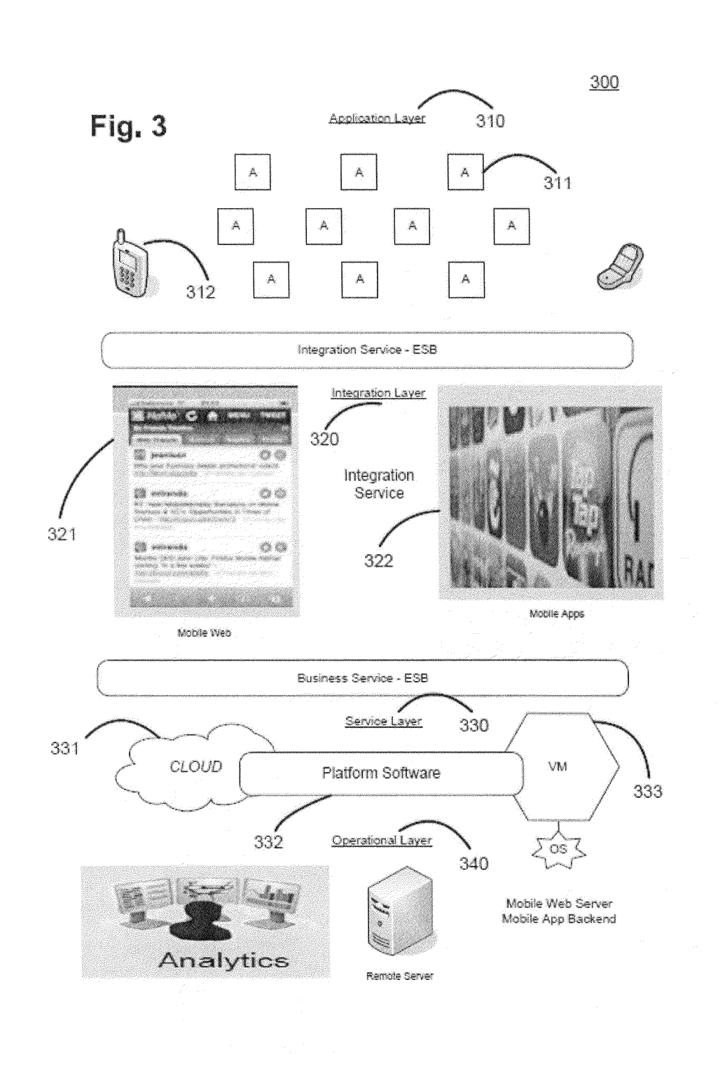

FIG. 3 illustrates an architectural framework 300 by which embodiments described herein could be implemented. An application layer 310 is illustrated, in which multiple mobile applications 311 for a specific industry, such as the health and medical industry are available for downloading to a mobile device 312. The architectural framework 300 is applicable for any other type of industry, such as the auto, music, entertainment, food, exercise, education, and travel industries, to name just a few. An integration layer 320 is illustrated in which mobile tools and products are available to a user, such as mobile web 321 and mobile applications 322. A service layer 330 is illustrated, in which the applications 311 are interconnected, via the cloud 331 to the interoperable platform 332 and associated JVM 333. The mobile applications 311 share some features of their individual application programming interface (API) with the platform 332 in order to integrate the applications 311 and their services with the platform 332. An operational layer 340 is illustrated, by which the applications 311 are made available to a user by a mobile web server and a mobile application backend infrastructure. The mobile application backend infrastructure includes a universal database tool containing an integrated development environment for database query, administration, and development.

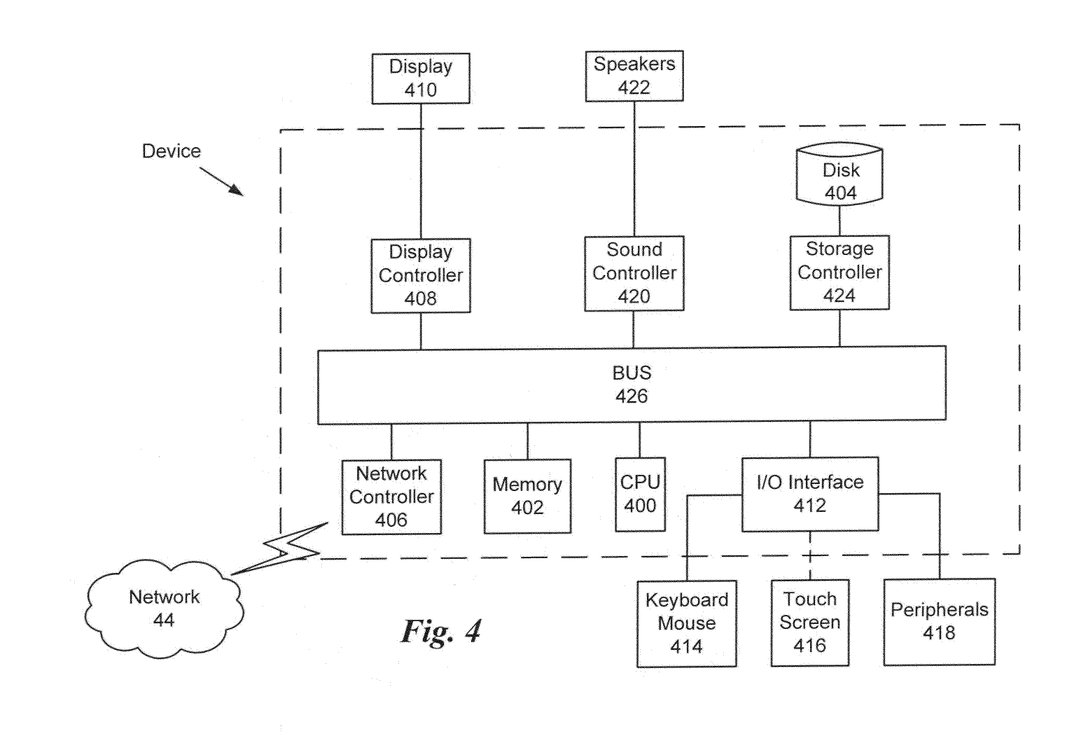

A hardware description of a computing device used in accordance with exemplary embodiments is described with reference to FIG. 4. In FIG. 4, the computing device includes a CPU 400 which performs the processes described above. The process data and instructions may be stored in memory 402. These processes and instructions may also be stored on a storage medium disk 404 such as a hard drive (HDD) or portable storage medium or may be stored remotely. Further, the claimed embodiments are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claimed embodiments may be provided as a utility application, background daemon, or component of an operating system, or combination thereof, executing in conjunction with CPU 400 and an operating system such as Microsoft Windows 7, UNIX, Solaris, LINUX, Apple MAC-OS and other systems known to those skilled in the art.

CPU 400 may be a Xenon or Core processor from Intel of America or an Opteron processor from AMD of America, or may be other processor types that would be recognized by one of ordinary skill in the art. Alternatively, the CPU 400 may be implemented on an FPGA, ASIC, PLD or using discrete logic circuits, as one of ordinary skill in the art would recognize. Further, CPU 400 may be implemented as multiple processors cooperatively working in parallel to perform the instructions of the inventive processes described above.

The computing device in FIG. 4 also includes a network controller 406, such as an Intel Ethernet PRO network interface card from Intel Corporation of America, for interfacing with network 44. As can be appreciated, the network 44 can be a public network, such as the Internet, or a private network such as an LAN or WAN network, or any combination thereof and can also include PSTN or ISDN sub-networks. The network 44 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 408, such as a NVIDIA GeForce GTX or Quadro graphics adaptor from NVIDIA Corporation of America for interfacing with display 410, such as a Hewlett Packard HPL2445w LCD monitor. A general purpose I/O interface 412 interfaces with a keyboard and/or mouse 414 as well as a touch screen panel 416 on or separate from display 410. General purpose I/O interface 412 also connects to a variety of peripherals 418 including printers and scanners, such as an OfficeJet or DeskJet from Hewlett Packard.

A sound controller 420 is also provided in the computing device, such as Sound Blaster X-Fi Titanium from Creative, to interface with speakers/microphone 422 thereby providing sounds and/or music.

The general purpose storage controller 424 connects the storage medium disk 404 with communication bus 426, which may be an ISA, EISA, VESA, PCI, or similar, for interconnecting all of the components of the computing device. A description of the general features and functionality of the display 410, keyboard and/or mouse 414, as well as the display controller 408, storage controller 424, network controller 406, sound controller 420, and general purpose I/O interface 412 is omitted herein for brevity as these features are known.

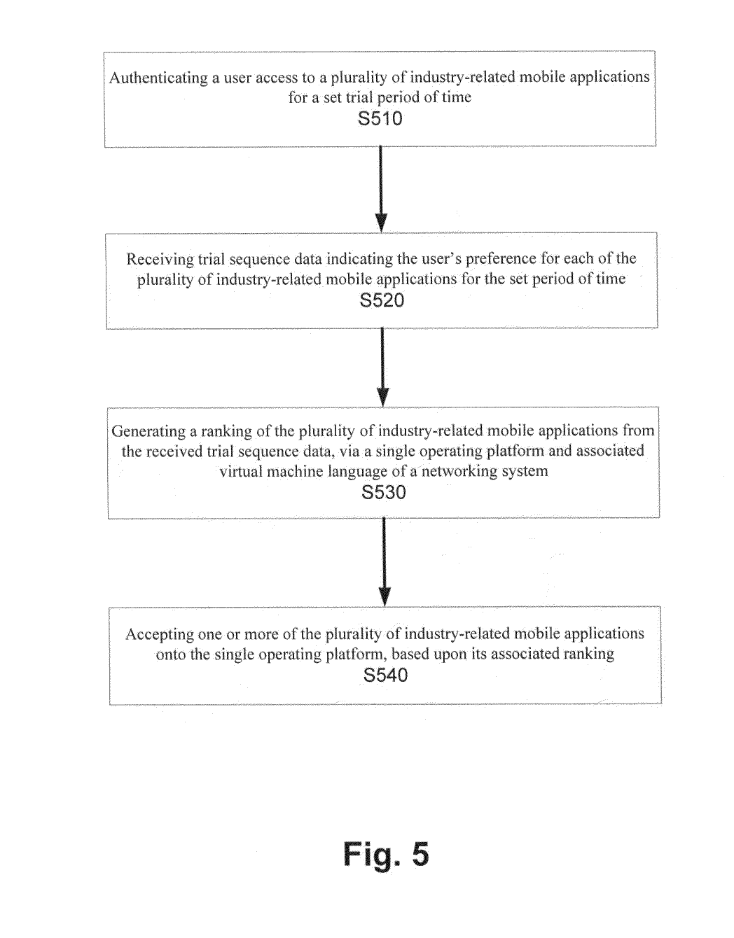

FIG. 5 is a flow diagram for a method of comparing mobile applications 500, using the architectural framework 300 and computing system 400 described above. A user access to a plurality of industry-related mobile applications is authenticated for a set trial period of time in step 510. Trial sequence data is received, which indicates the user's preference for each of the plurality of industry-related mobile applications for the set period of time in step 520. A ranking of the plurality of industry-related mobile applications is generated from the received trial sequence data, via a single operating platform and associated virtual machine language of a networking system in step 530. One or more of the plurality of industry-related mobile applications is accepted onto the single operating platform, based upon its associated ranking in step 540.

Embodiments will now be discussed, in which the methods and systems described herein are utilized within the medical and health industry. However, the embodiments discussed (or other analogous embodiments) can also be applied to most other industries, including but not limited to the auto, music, entertainment, food, exercise, education, and travel industries without departing from the scope of the present disclosure.

In a first embodiment, informational data related to a patient's medical condition is received from a server, such as the server 341 illustrated in FIG. 3. Based upon the medical condition of the patient derived from the received informational data, a recommendation is forwarded to the patient for one or more mobile health applications from the medical and health platform, such as platform 332. One or more services of relevant medical applications may also be forwarded to the patient.

In a second embodiment, informational data related to a patient's medical condition is received from a server. The received informational data is outputted into corresponding data fields of a mobile health application.

In a third embodiment, a mobile health application is received by a host device. The host device determines data fields that are currently unpopulated in a mobile health application. The host device obtains data that corresponds to the unpopulated fields from a server that has an applicable record, such as an electronic record server. For example, a mobile health allergy application for a patient may contain data that a mobile health prescription application needs for that patient. The relevant data from the allergy application is obtained from the server by the host device, and the data is populated into the prescription application.

In a fourth embodiment, an authentication to access a plurality of mobile health applications containing de-identified data sets is received for a predetermined trial period. Following the trial period, pairwise trial sequence data indicating a user's preference for each of the mobile health applications with respect to the other applications is received. A ranking for each of the applications is generated, based on the pairwise trial sequence data.

In a fifth embodiment, a marketplace service would function as a personalized electronic medical records storage (pEMR). The pEMR would gather new medical data collected with each new application download. If a user downloads a new application that requires information from the user that had not been requested previously, such as blood type, the pEMR would expand its data collection for that user by one new field, i.e. blood type. The pEMR would make it available to subsequent applications when requested, if approved by the user. This bi-directional nature would prevent the need to create an EMR that anticipates all information requests before the need arises.

In addition to integrating with other health applications and systems, a mobile medical or health application should have certain features in order to be useful, helpful, and effective. The application needs to be fit for the purpose, whether it is intended for a patient, physician, healthcare provider, or clinician. It should also be attractive and adapted to the environment of the user. The same general purpose application could have several different versions for different users, as well as different versions for the same type of user. For example, a mobile health application's purpose may be to manage health-related appointments. The patient would have use for such an application, as well as the individual health entities (e.g. doctor's offices, diagnostic or laboratory facilities, or physical therapy facilities). In addition, such an application geared to the patient could have different versions for a child, young adult, and senior adult. Other combinations of mobile health applications and versions of those applications are contemplated by embodiments described herein.

The mobile health application should store the data securely and according to any local laws and regulations. For example, the Health Insurance Portability and Accountability Act (HIPAA) has five regulations with standards or rules for privacy, security, transactions and code sets, unique identifiers, and HITECH enforcement. The first HIPAA regulation is the Privacy Rule, which mandates the protection and privacy of all health information. The Privacy Rule defines the authorized uses and disclosures of “individually-identifiable” health information. The Privacy Rule sets requirements for how protected health information (PHI), in any form or medium is controlled. The second HIPAA regulation is the Security Rule, which mandates the security of electronic medical records (EMR). The Security Rule addresses the technical aspects of protecting electronic health information, including administrative security, physical security, and technical security. The third HIPAA regulation is the Transactions and Code Set Rule (TCS), which addresses the use of predefined transaction standards and code sets for communications and transactions in the health-care industry. The fourth HIPAA regulation is the Unique Identifiers Rule, which has three unique identifiers used for covered entities in HIPAA transactions to promote standardization, efficiency, and consistency. The fifth HIPAA regulation is the Enforcement Rule, which stems from the HITECH Act. The Enforcement Rule expands the scope of the Privacy and Security Rules, and increases the reach and penalties for HIPAA violations.

Protected health information (PHI) is any information about the health status, a provision of health care, or a payment for health care that can be linked to a specific individual. This is interpreted to include any part of a patient's medical record or payment history. PHI is often sought out in datasets for de-identification before researchers share the dataset publicly. Removing PHI from a dataset preserves privacy for the research participants. Under HIPAA, PHI is based on 18 identifiers that must be treated with special care. Those 18 identifiers include names, all geographical identifiers smaller than a state, dates directly related to an individual, phone numbers, fax numbers, email addresses, Social Security numbers, medical record numbers, health insurance beneficiary numbers, account numbers, certificate/license numbers, vehicle identifiers and serial numbers, device identifiers and serial numbers, web Uniform Resource Locators (URLs), Internet Protocol (IP) address numbers, biometric identifiers, full face photographic images, and any other unique identifying number, characteristic, or code.

De-identification under the HIPAA rule occurs when data has been stripped of the above common identifiers by either removing all 18 specific identifiers, or by obtaining the expertise of an experienced statistical expert to validate and document the statistical risk of re-identification as being very small, according to a statistical method. Anonymization is a process in which PHI elements are eliminated or manipulated with the purpose of hindering the possibility of going back to the original data set. This involves removing all identifying data to create unlinkable data. De-identified data is coded, with a link to the original, fully identified data set. Links exist in coded de-identified data, making the data considered indirectly identifiable and not anonymized. Coded de-identified data is not protected by the HIPAA Privacy Rule, but is protected under the Common Rule. When de-identification and anonymization are used together, health care data can be used in larger increments and still abide by HIPAA regulations.

A mobile health application should also have any necessary certifications in place. The realm of mobile health applications is very large, and any necessary certifications will also span a large spectrum. Therefore, a good mobile health application will have any required certifications readily visible.

A mobile health application becomes much more valid when it is supported by any relevant scientific backing. For example, a mobile health application may pertain to a dental process. Therefore, a valid scientific backing might include a statement that the American Dental Association has approved or certified the application. Many other purposes and associated backings are contemplated by embodiments described herein.

A mobile health application should be easily implemented. Many applications, including applications other than mobile or health-related applications may have a valuable and/or interesting purpose, but are difficult to implement. As a result, the user gives up and is disappointed that it did not fulfill his/her need.

A mobile application needs to be credible in order for professionals within that industry to prescribe, recommend, or endorse the application. If all HIPAA regulations were adhered to in an application, it would likely render the application credible. For the medical and health industry, a physician is likely to prescribe a particular mobile application if the application has a credible health-related backing, such as the US Food and Drug Administration (FDA). However, not all applications originate from the United States, and those application authors may not bother to seek FDA approval or adhere to HIPAA regulations. In addition, the waiting period for FDA approval can be lengthy. An embodiment of the invention includes a list of criteria, established by the governing platform, which all mobile applications must meet. Another embodiment includes not publishing or going live with the application until it has met those criteria and is approved by the platform.

As time progresses with the approval of mobile applications by a platform, a natural clustering of applications will occur. In the health and medical industry, certain medical conditions may likely catalyze a cluster of applications around that condition. For example, a diabetic cluster may form, which might include a glucose monitoring application, a diet application, a social network application, and a medical supplies ordering application. A second example includes an auto clustering, in which applications may cluster in the areas of race cars, antique cars, trucks, and green cars to name just a few. A third example includes a music cluster, in which applications may cluster by music genre. To facilitate any type of clustering, the platform marketplace could provide cluster-specific suggestions that match profiles of similar users.

An extension of clustering is also provided by embodiments of the present disclosure. Mobile applications are integrated together by industry onto a platform. Clustering occurs and cluster-specific suggestions can be made, as discussed above. A user's data can also be applied against multiple applications. As a result, different applications can be cross-matched to a user. In addition, overlapping of more than one cluster can occur. For example, in the health and medical industry, a patient/user may have more than one medical condition, especially with chronic symptoms. Therefore, this particular user could have several application links, from user-designated applications and from marketplace-suggested applications. In addition, marketplace arrangements can be set up for application bundle purchases.

Embodiments of the present disclosure provide an evaluation and validation of mobile applications that focus on increasing the number of high quality and safe mobile applications, and promote collaboration between practitioners, innovators, developers, and academics. Embodiments described herein also create a community of interest to drive ideas into practice.

With regard to the medical and healthcare industry, the rise of the hyper-connectivity allows real-time patient monitoring through wearable mobile applications that are connected wirelessly to machines at a physician's office through e-health applications. This allows real-time interactions between patients and their healthcare providers to improve health outcomes and ultimately save lives.

The potential impact of mobile health application prescribing for a patient's care has the following advantages. For patients, embodiments described herein improve access to health care, improve quality of health care, decrease hospitalization, and decrease costs. For physicians, embodiments described herein provide personalized treatment plans, improve patient satisfaction and outcomes, and increase referrals. For health care providers, embodiments described herein move towards a more patient-centric or performance-based model of care delivery, and promote the mobile applications that make patients engage in their own health management between appointments.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A method of comparing mobile applications, the method comprising:
authenticating a user access to a plurality of industry-related mobile applications for a set trial period of time;
receiving trial sequence data indicating the user's preference for each of the plurality of industry-related mobile applications for the set period of time;
generating a ranking of the plurality of industry-related mobile applications from the received trial sequence data, via a single operating platform and associated virtual machine language of a networking system; and
accepting one or more of the plurality of industry-related mobile applications onto the single operating platform, based upon its associated ranking.

2. The method of claim 1, wherein the industry-related mobile applications contain mobile applications from the medical and health industry.

3. The method of claim 1, wherein the user compares each of the plurality of industry-related mobile applications for the set trial period of time.

4. The method of claim 3, wherein the user rates each of the plurality of industry-related mobile applications via a set of industry-related criteria.

5. The method of claim 1, wherein the ranking is generated via one of a pairwise ranking, a list-wise correlation, or a multiple alignment technique.

6. The method of claim 1, wherein the accepting includes consideration of a third-party validation of the plurality of industry-related mobile applications.

7. The method of claim 6, further comprising:
outputting the accepted mobile application to an interface connected to a server from which the mobile application may be transmitted.

8. The method of claim 1, further comprising:
receiving information related to the user and outputting a recommendation for one or more industry-related mobile applications, based upon the received information.

9. The method of claim 1, further comprising:
receiving information related to the user and outputting some of the received information that corresponds to data fields in another mobile application.

10. The method of claim 1, further comprising:
determining, when a mobile application is received, data fields that are currently unpopulated in the received mobile application; and
obtaining data corresponding to the unpopulated data fields from a record server.

11. The method of claim 1, wherein each of the plurality of industry-related mobile applications share an application programming interface with the single operating platform.

12. The method of claim 1, further comprising:
de-identifying protected information from the received trial sequence data.

13. The method of claim 1, further comprising:
receiving data from some of the plurality of industry-related mobile applications used by the user, and integrating the data into a single application.

14. The method of claim 13, further comprising:
clustering the received data from some of the plurality of industry-related mobile applications; and
recommending new related mobile applications to the user from the clustered received data.

15. A mobile application network system, comprising:
an interoperable platform and associated virtual machine language;
a plurality of mobile applications that are related to a single industry, and interconnected with the interoperable platform via a networking system, wherein some of the plurality of mobile applications are evaluated by a user and accepted by the interoperable platform, based upon each mobile application's resultant ranking;
an operating system connected to the interoperable platform; and
a server, comprising a processor,
wherein each of the plurality of mobile applications share an application programming interface with the interoperable platform, such that the mobile application network system has a single interoperable platform, a single operating system, and a single server for the plurality of mobile applications that are related to the single industry.

16. The mobile application network system of claim 15, wherein each of the mobile application's resultant ranking includes an equal-time comparison by a user of at least two of the plurality of mobile applications according to industry-related criteria.

17. The mobile application network system of claim 16, wherein the resultant ranking is generated via one of a pairwise ranking, a list-wise correlation, or a multiple alignment technique.

18. The mobile application network system of claim 16, wherein the plurality of mobile applications accepted by the interoperable platform include a third-party validation.

19. The mobile application network system of claim 15, further comprising:
user data from a record server, inputted into an unpopulated data field of a received mobile application.

20. The mobile application network system of claim 15, further comprising:
integrated data into a single mobile application, received from some of the plurality of mobile applications.
